(19) United States
(12) Patent Application Publication
(10) Pub. No.: US 2014/0257791 A1
(43) Pub. Date: Sep. 11, 2014

(54) APPARATUS AND METHOD FOR AUTO-GENERATION OF JOURNAL ENTRIES

(71) Applicant: SONY CORPORATION, Tokyo (JP)

(72) Inventor: Ly Kao Nhiayi, San Diego, CA (US)

(73) Assignee: SONY CORPORATION, Tokyo (JP)

(21) Appl. No.: 13/792,801

(22) Filed: Mar. 11, 2013

(51) Int. Cl. G06F 17/27

(52) U.S. Cl. CPC G06F 17/274
USPC 704/9

(57) ABSTRACT

Various aspects of an apparatus and method for auto-generation of journal entries may include an electronic device. The electronic device receives information associated with a user from one or more sources. The electronic device analyzes the received information to determine information to be included in the journal entry. The electronic device determines a writing style of the user based on the received information. The electronic device generates one or more sentences for the journal entry based on the determined journal information, the determined writing style of the user, and one or more pre-determined parameters associated with the user.

### FIELD

Various embodiments of the disclosure relate to journal entries. More specifically, various embodiments of the disclosure relate to method and apparatus for auto-generation of journal entries.

### BACKGROUND

The World Wide Web provides several platforms for a user to post and/or share comments based on personal interest. These platforms may include a blog, an online diary and/or a social media website. A user may make entries in a personal diary or blog or on social media websites to catalog or share activities or interactions. It may be difficult for the customer to remember all the activities of a given day and manually make an entry corresponding to each activity.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

An apparatus and method are provided for auto-generation of journal entries substantially as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram illustrating a system environment in which the present disclosure may be implemented, in accordance with an embodiment of the disclosure.

FIG. 2 is a block diagram illustrating a user device comprising a sentence generating apparatus, in accordance with an embodiment of the disclosure.

FIG. 3 is a block diagram illustrating a server comprising a sentence generating apparatus, in accordance with an embodiment of the disclosure.

FIG. 4A is a block diagram illustrating a sentence generating apparatus associated with a journal unit and sources of information, in accordance with an embodiment of the disclosure.

FIG. 4B is a block diagram illustrating multiple sensors associated with a sentence generating apparatus, in accordance with an embodiment of the disclosure.

FIG. 5 is a block diagram illustrating a sentence generating apparatus, in accordance with an embodiment of the disclosure.

FIG. 6 illustrates a list of entries generated by a sentence generating apparatus, in accordance with an embodiment of the disclosure.

FIG. 7 is a flow chart illustrating a method for generating sentences, in accordance with an embodiment of the disclosure.

FIG. 8 is a flow chart illustrating another method for generating sentences, in accordance with an embodiment of the disclosure.

FIG. 9 is a flow chart illustrating another method for generating sentences, in accordance with an embodiment of the disclosure.

### DETAILED DESCRIPTION

The following described implementations may be found in an apparatus and/or method for auto-generation of journal entries.

Exemplary aspects of the disclosure may comprise the method for generating a journal entry in an electronic device. The method may include receiving information associated with a user from one or more sources. The method may include analyzing the received information to determine journal information to be included in the journal entry. The method may include determining a writing style of the user based on the received information. The method may include generating one or more sentences for the journal entry based on the determined journal information, the determined writing style of the user, and one or more pre-determined parameters associated with the user.

The method may further comprise generating one or more sentences for the journal entry based on a weight assigned to each of the one or more pre-determined parameters associated with the user. The received information may be one or more of a location, an activity of the user, weather at the location, previous journal entries of the user, a personal profile of the user, and the like. The one or more sources may be pre-defined by the user. The one or more sources may be the World Wide Web and/or one or more sensors. The one or more pre-determined parameters may comprise one or more of an age of the user, a gender of the user and/or an educational background of the user, and the like.

In accordance with another embodiment of the disclosure, an apparatus and/or method for generating one or more sentences is disclosed. Exemplary aspects of the disclosure may include aggregating metadata associated with a user from one or more sources. The method may include determining a writing style associated with the user based on received user input. The method may include generating the one or more sentences based on the aggregated metadata, the determined writing style, and one or more pre-determined parameters associated with the user. The received user input may comprise one or more of a particular writing style, an e-mail written by the user, a text message written by the user, and/or a journal entry written by the user. The method may further include generating one or more subsequent sentences linked to previously generated one or more sentences based on the aggregated metadata, the selected writing style, and one or more pre-determined parameters associated with the user. The one or more pre-determined parameters may comprise one or more of an age of the user, a gender of the user and/or an educational background of the user. The method further includes generating the one or more sentences based on a weight assigned to each of the one or more pre-determined parameters.

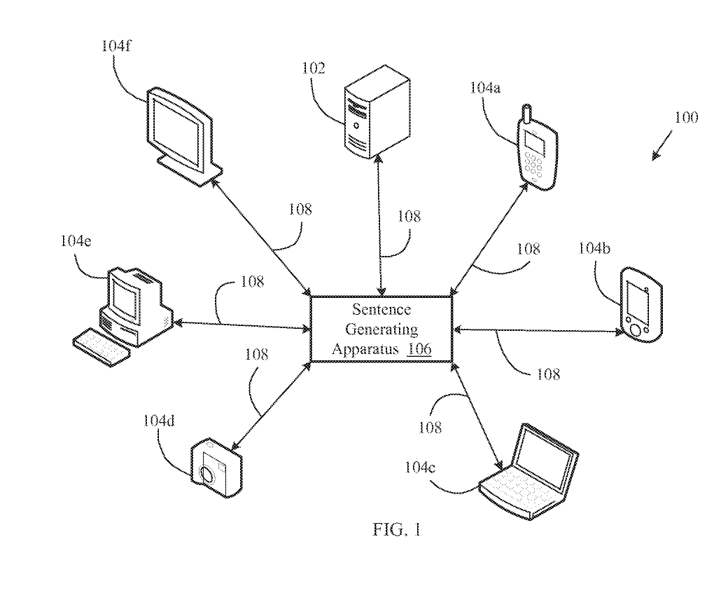

FIG. 1 is a block diagram illustrating a system environment in which the present disclosure may be implemented, in accordance with an embodiment of the disclosure. With reference to FIG. 1, there is shown a network environment 100. The network environment 100 may comprise a server 102, user devices (104a, 104b, 104c 104d, 104e, 104f, and/or the like, hereinafter referred to collectively as user devices 104), a sentence generating apparatus 106, and a communication network 108. One or more servers (such as server 102) and the user devices 104 may be communicably coupled to the sentence generating apparatus 106 via a suitable communication network 108.

The server 102 may comprise suitable logic, circuitry, interfaces, and/or code that may be operable to perform computations and comprises at least one database and at least one processor. The server 102 may store one or more of the plurality of contents accessed by the user devices 104. In an embodiment, the server 102 may store profile information of users, information related to particular location, place, and/or the like. In an embodiment, the server 102 may assign a distinct user profile which corresponds to each of the registered users. The user profile may include data which corresponds to the user which may define a user's personal preferences and characteristics. The user profile may also include dynamic data, such as the location of user, current activity of the user and/or the user device (such as user device 104a).

The user devices 104 may correspond to an electronic device and comprise suitable logic, circuitry, interfaces, and/or code that may be operable to display information, such as video and/or audio-visual content. The user devices 104 may include a computing device that produces, streams or downloads information and a display screen or a projection surface that displays the information. In an embodiment, the display device includes the display screen and the computing unit integrated as a single unit. In an embodiment, the display device includes the computing device and the display screen as separate units. Examples of display devices include, but are not limited to, laptops, televisions (TV), tablet computers, desktop computers, mobile phones, gaming devices, and other such devices that have display capabilities.

The sentence generating apparatus 106 may comprise suitable logic, circuitry, interfaces, and/or code that may be operable to generate sentences and/or phrases using the information gathered from the World Wide Web and/or sensors associated with the electronic devices (such as a user device 104a) in proximity to the user. In accordance with an embodiment, the sentence generating apparatus 106 may be within the user device (such as user device 104a). In accordance with another embodiment, the sentence generating apparatus 106 may be within the server 102.

The communication network 108 corresponds to a medium through which various components of the network environment 100 communicate with each other. Examples of the communication network 108 may include, but are not limited to, a television broadcasting system, an Internet Protocol television (IPTV) network, the Internet, a Wireless Fidelity (Wi-Fi) network, a Wireless Area Network (WAN), a Local Area Network (LAN), a telephone line (POTS), or a Metropolitan Area Network (MAN). The server 102 and the user devices (such as user devices 104) in the network environment 100 may connect to the sentence generating apparatus 106 via the communication network 108, in accordance with various wired and wireless communication protocols, such as Transmission Control Protocol and Internet Protocol (TCP/IP), User Datagram Protocol (UDP), 2G, 3G, or 4G communication protocols. Further, the communication network 108 may connect the sentence generating apparatus 106 to the one or more user devices 104 and the one or more servers (such as server 102).

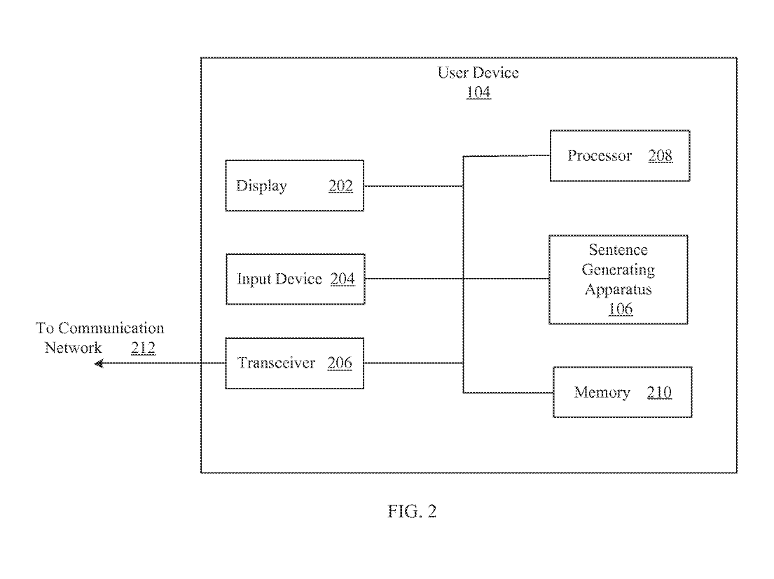

FIG. 2 is a block diagram illustrating a user device (such as user device 104a) comprising the sentence generating apparatus, in accordance with an embodiment of the disclosure. FIG. 2 is explained in conjunction with elements from FIG. 1. With reference to FIG. 2, there is shown the user device (such as user device 104a) comprising a display 202, an input device 204, a transceiver 206, one or more processors (such as processor 208), the sentence generating apparatus 106, and a memory 210. The sentence generating apparatus 106 may be operable to receive input (information) through the transceiver 206, from the memory 210 and/or the input device 204. The sentence generating apparatus 106 may be operable to display the generated sentence to the user via the display 202. The one or more processors (such as processor 208) may be operable to process the received information to generate one or more sentences.

In accordance with an embodiment, the transceiver 206 may be operable to receive information from one more other devices (such as user device 104b) and/or the server 102. The input device 204 may be operable to receive the information from the user. The memory 210 may be operable to store the received information and/or generated sentences.

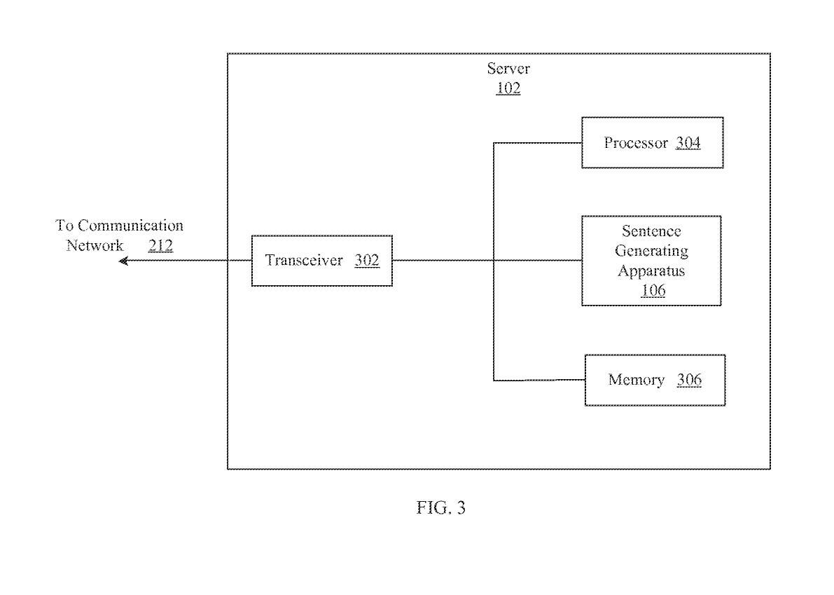

FIG. 3 is a block diagram illustrating a server comprising the sentence generating apparatus, in accordance with an embodiment of the disclosure. FIG. 3 is explained in conjunction with elements from FIG. 1. With reference to FIG. 3, there is shown the server 102 comprising the sentence generating apparatus 106, a transceiver 302, one or more processors (such as processor 304), and a memory 306. The transceiver 302, the processor 304, and the memory 306 may be substantially similar to the transceiver 206, the processor 208, and the memory 210 respectively, as described with respect to FIG. 2.

The sentence generating apparatus 106 may receive input (information) via the transceiver 302 and/or the memory 306. The one or more processors (such as processor 304) may be operable to process the received information to generate one or more sentences. The memory 306 may be operable to store the received information and/or the generated sentences.

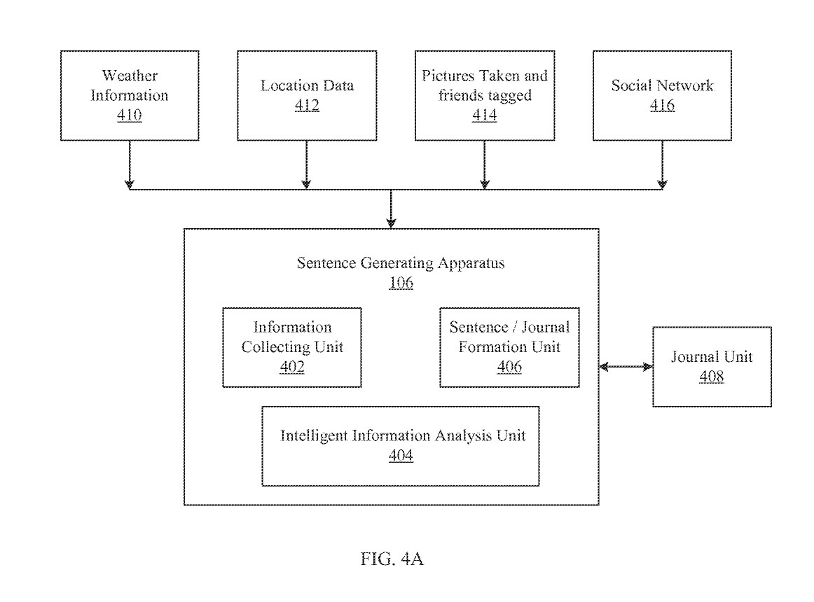

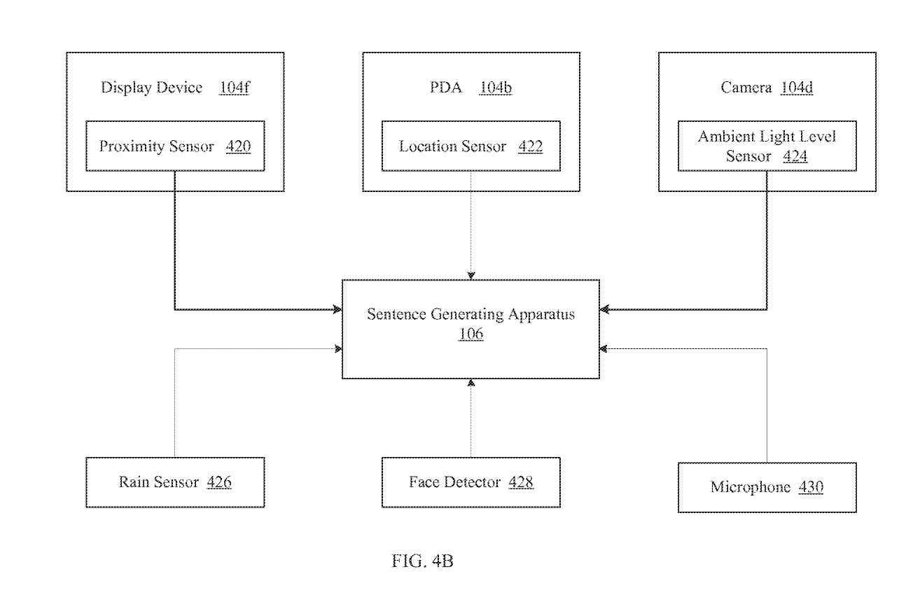

FIG. 4A is a block diagram illustrating a sentence generating apparatus associated with a journal unit and sources of information, in accordance with an embodiment of the disclosure. FIG. 4A is explained in conjunction with elements from FIG. 1. With reference to FIG. 4A, there is shown the sentence generating apparatus 106, a journal unit 408, and one or more sources of information 410, 412, 414, and 416. The sentence generating apparatus 106 may comprise an information collecting unit 402, an intelligent information analysis unit 404, and a sentence/journal formation unit 406. The sentence generating apparatus 106 may receive information and/or metadata, such as weather information 410, location data 412, pictures taken and friends tagged 414, and/or information from social networks (such as a social network 416). In an embodiment, the sentence generating apparatus 106 may receive information from one or more sensors associated with user devices (such as user device 104d) in proximity to the user. In an embodiment, the information and/or metadata from the social network 416 may include a user profile of the user, user profiles of other people, a relationship of the user with the other people, and the like. The user profile may include information, such as age, gender and/or educational background of the user, for example.

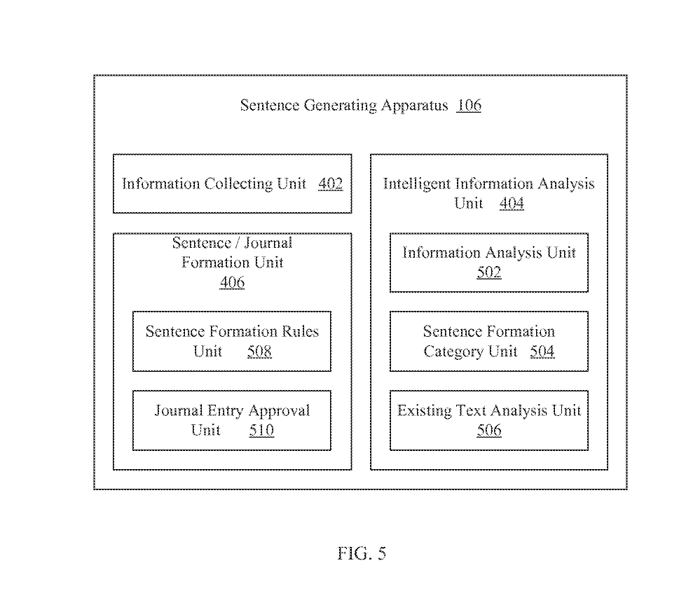

FIG. 4B is a block diagram illustrating multiple sensors associated with a sentence generating apparatus, in accordance with an embodiment of the disclosure. FIG. 4B is explained in conjunction with elements from FIG. 1. With reference to FIG. 4B, there is shown the sentence generating apparatus 106, a proximity sensor 402 associated with a display device (such as a user device 104f), a location sensor 422 associated with a PDA (such as a user device 104b), an ambient light level sensor 424 associated with a camera (such as a user device 104d), a rain sensor 426, a face detector 428 and/or a microphone 430. In an embodiment, the information collecting unit 402 may collect the weather information 410 from different sources, such as the World Wide Web and/or sensors in proximity to the user. Examples of weather sensors may be the ambient light level sensor 428 in the camera (such as user device 104d) and/or a mobile phone, the rain sensor in a car, and/or the like. In an embodiment, the information collecting unit 402 may collect the location data from the proximity sensor 420, the location sensor 422, and the like. In an embodiment, the information collecting unit 402 may collect information, such as pictures taken by a camera (such as user device 104d) in the user devices 104, a list of friends tagged to a picture and/or identifying the friends along with the user. In an embodiment, the list of friends tagged to a picture may be obtained from the social media websites (such as social network 416). In an embodiment, friends may be identified by comparing the location of the user and the friends, a voice recognition application in the user device (such as user device 104b), and/or a face identification application in the user device (such as user device 104f). In an embodiment, the information collecting unit 402 may collect information regarding the user from social media websites (such as social network 416). The information collecting unit 402 may also collect information about the user's friends or family members from social media websites (such as social network 416). In an embodiment, the information collecting unit 402 may also collect information directly from the user. The intelligent information analysis unit 404, and the sentence/journal formation unit 406 will be explained in more detail with respect to FIG. 5.

FIG. 5 is a block diagram illustrating a sentence generating apparatus, in accordance with an embodiment of the disclosure. FIG. 5 is explained in conjunction with elements from FIG. 1 and FIG. 4. With reference to FIG. 5, there is shown the sentence generating apparatus 106 comprising an information collecting unit 402, an intelligent information analysis unit 404 and a sentence/journal formation unit 406. The intelligent information analysis unit 404 further includes an information analysis unit 502, a sentence formation category unit 504 and an existing text analysis unit 506. The sentence/journal formation unit 406 further includes a sentence formation rules unit 508 and a journal entry approval unit 510.

The information collecting unit 402 may collect information regarding the location and an activity of the user from various sources. The information collecting unit 402 may collect information text entries that the user has previously generated. The information collecting unit 402 provides the collected information to the intelligent information analysis unit 404. The intelligent information unit 404 may be operable to process the collected information and generate one or more parameters. The parameters generated by the intelligent information unit 404 may be input to the sentence/journal formation unit 406. The sentence/journal formation unit 406 may be operable to generate one or more sentences using the parameters. The parameters may comprise one or more of the age of the user, the gender of the user, the educational background of the user, a location of the user, an activity of the user, people involved in the user's activity, the user devices 104 involved in the user's activity, and the like.

In an embodiment, the information analysis unit 502 may be operable to process the collected information provided by the information collecting unit 402 to identify one or more of the location, the activity of the user, people involved in the user's activity, the user devices 104 involved in the user's activity, and the like. The sentence formation category unit 504 may be operable to process the collected information provided by the information collecting unit to identify the situation of the user, which may then be correlated with a behavioral pattern of the user to recognize the mood or emotion of the user. The existing text analysis unit 506 may be operable to process the existing text entered by the user to determine a writing style of the user.

In an embodiment, the information analysis unit 502 may be operable to generate weights associated with the parameters. The weights associated with a parameter (such as a location, an activity, a person and/or a user device) may be a numerical value which indicates the preference or interest of the user in the parameter. In an embodiment, the higher the value of the weight associated with a parameter, the higher the probability of using the parameter in a generated sentence. The information analysis unit 502 may utilize artificial intelligence algorithms to generate the weight associated with the parameters. The information analysis unit 502 may use information, such as user's interest and/or relationship with the parameters to generate the weight. The information analysis unit 502 may obtain the details from social media websites and/or directly from the user. In an embodiment, the information analysis unit 502 may also take into consideration, information from the profile or websites of the identified person or location for generating weights. In an embodiment, the weight may be assigned to pre-determined parameters related to the user, such as an age of the user, a gender of the user and/or an educational background of the user.

The sentence formation category unit 504 may utilize artificial intelligence algorithms to process the information received from the information collecting unit 402. In an embodiment, the sentence formation category unit 504 may receive parameters, such as a location, activity of the user, people involved in the user's activity and/or user devices 104 involved in the user's activity, as an input. The sentence formation category unit 504 may be operable to generate the behavioral pattern of the user based on the information extracted from social media websites, information obtained directly from the user, information about the activities of the user, and the like. The activities of the user may include one or more of browsing, screen time, participation in indoor and outdoor games, travel, and the like. In an embodiment, the sentence formation category unit 504 may obtain the behavioral pattern of the user as input information through the information collecting unit 402. The sentence formation category unit 504 may further use artificial intelligence algorithms to recognize or categorize the situation of the user. In an embodiment, the situation may describe the user's level of involvement or participation in the activity. The sentence formation category unit 504 may determine the mood of the user, such as happy, angry, aggressive or excited, based on the behavioral pattern and the mood.

In an embodiment, the sentence formation category unit 504 may be operable to generate weights associated with the mood. In an embodiment, the weight shows the intensity of the mood. The weight associated with the mood may vary for different moods, such as happy, angry, aggressive or excited. For example, the rate of increase of a value corresponding to the weight for anger may be less than that for happiness. In an embodiment, the weight may be affected by approvals of the user to sentences generated earlier with the same mood as one of the parameters. In an embodiment, the weight of the mood of the user may be affected by one or more of the mood of other people involved in the activity, location of the user, user preferences, and the like.

The existing text analysis unit 506 may obtain text entries that the user has previously generated, such as short message service (SMS), e-mails and/or journal entries, from the information collecting unit 402. To identify the writing style of the user, the existing text analysis unit 506 may utilize artificial intelligence algorithms to process information received from the information collecting unit 402. The existing text analysis unit 506 may parse, analyze syntax/sentence structure, identify frequently used words, and the like, to determine the writing style of the user.

In an embodiment, the existing text analysis unit 506 may allocate weight to the words commonly used by the user, the sentence structures commonly used by the user, and the like. In an embodiment, the value of the weight may increase with the frequency of usage of the word and/or the sentence structure by the user.

The weight associated with a parameter (such as a location, an activity, a person, a user device, mood, and/or frequently used words) may be a numerical value within a range (for example, range may be 0 to 1, and weights may have values 0.2, 0.36, 0.93, and the like) which indicates the preference or interest of the user in the parameter. In an embodiment, the weights may be assigned as pre-defined values, such as numerical values and/or levels. The pre-defined level, such as HIGH, MEDIUM and/or LOW, may be assigned as weight values of a parameter based on the decreasing relevance of the parameter to the user respectively. The pre-defined numerical values, such as 3, 2 and/or 1, may be assigned as weight values of a parameter based on the decreasing relevance of the parameter to the user respectively. The relevance of the parameter to the user may be decided based on one or more of the user profile information and/or the current activity of the user.

In an embodiment, the sentence/journal formation unit 406 may comprise a sentence formation rules unit 508 and a journal entry approval unit 510. The sentence formation rules unit 508 may receive information from one or more of the information analysis unit 502, the sentence formation category unit 504 and the existing text analysis unit 506. The sentence formation rules unit 508 generates one or more structured sentences based on the received input. The journal entry approval unit 510 may receive approval from the user for entering the generated sentences in a journal.

In an embodiment, the sentence/journal formation unit 406 uses artificial intelligence algorithms to generate one or more structured sentences from the received information. In an embodiment, the sentence formation rules unit 508 may be operable to generate one or more structured sentences from the received input based on the weights associated with the received input. The sentence formation rules unit 508 may select parameters with higher weight values. The sentence formation rules unit 508 may use the parameter with a highest value for the associated weight from a group of the same type of parameters received from the intelligent information analysis unit 404. In an embodiment, the sentence/journal formation unit 406 uses artificial intelligence algorithms to generate one or more structured sentences based on the weights assigned to pre-determined parameters, such as an age of the user, a gender of the user and/or an educational background related to the user.

In an embodiment, the journal entry approval unit 510 may provide an option to the user to approve the generated sentence and/or discard the generated sentence. In an embodiment, the journal entry approval unit 510 may provide a user multiple options for the journal. The journal may be a personal online diary/e-diary, a social media website, an official record, and/or the like. Notwithstanding, the disclosure may not be so limited, and other locations may be utilized to display the generated one or more sentences without limiting the scope of the disclosure. The user may select one or more of the options from the list of journals, where the generated sentences may be entered. In an embodiment, the journal entry approval unit 510 adds one or more of time and date of generation of sentence with the approved entry.

In an embodiment, the journal unit 408 associated with the sentence generating apparatus 106 may prepare the personal online diary/e-diary using the sentences approved by the user. The journal unit 408 receives the sentences approved by the user for the personal online diary/e-diary. The personal online diary/e-diary prepared by the journal unit may be stored in the server 102. In an embodiment, the journal prepared may be stored in the user device (such as user device 104b).

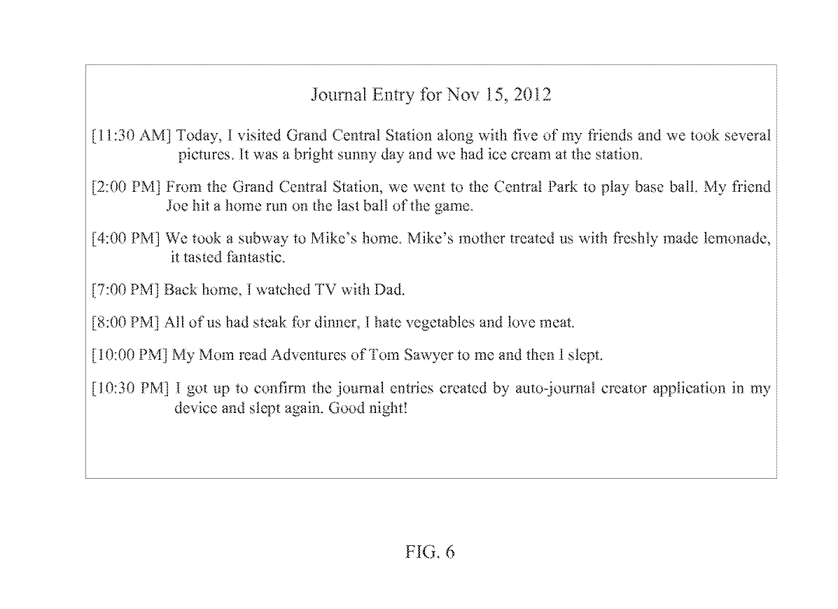

FIG. 6 illustrates a list of entries generated by a sentence generating apparatus, in accordance with an embodiment of the disclosure. FIG. 6 shows the personal online diary/e-diary with the sentences generated by the sentence generating apparatus 106.

In an embodiment where the sentence generating apparatus 106 may be located at the server 102, the journal entry approval unit 510 may have an additional function of communicating the generated sentences to the user device (such as user device 104b). The user device (such as user device 104b) may display the received generated sentence along with the options for the journal.

In an embodiment, the sentence generating apparatus 106 may be implemented partly at the server 102 and partly at the user device (such as user device 104b). The information collecting unit 402 and the intelligent information analysis unit 404 may be implemented at the server 102. The sentence/journal formation unit 406 may be implemented at the user device (such as user device 104b). The collection of information and intelligent analysis of the collected information may be performed at the server 102, as disclosed in previous embodiments. The parameters generated by the intelligent information analysis unit 404 may be communicated to the sentence/journal formation unit 406 at the user device (such as user device 104b). The sentence/journal formation unit 406 at the user device (such as user device 104b) functions as disclosed in previous embodiments to generate sentences from the received parameters.

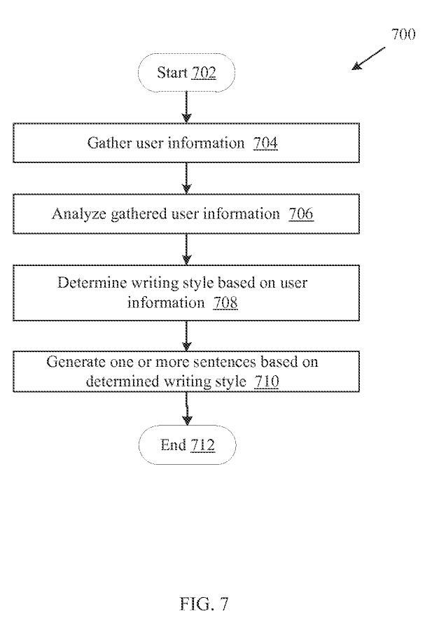

FIG. 7 is a flow chart illustrating a method for generating sentences, in accordance with an embodiment of the disclosure. FIG. 7 is explained in conjunction with elements from FIG. 1. With reference to FIG. 7, exemplary steps may begin at step 702. At step 704, the sentence generating apparatus 106 may gather user information. At step 706, the sentence generating apparatus 106 may analyze the gathered user information. At step 708, the sentence generating apparatus 106 may determine a writing style based on user information. At step 710, the sentence generating apparatus 106 may generate one or more sentences based on the determined writing style. Control then passes to end step 712.

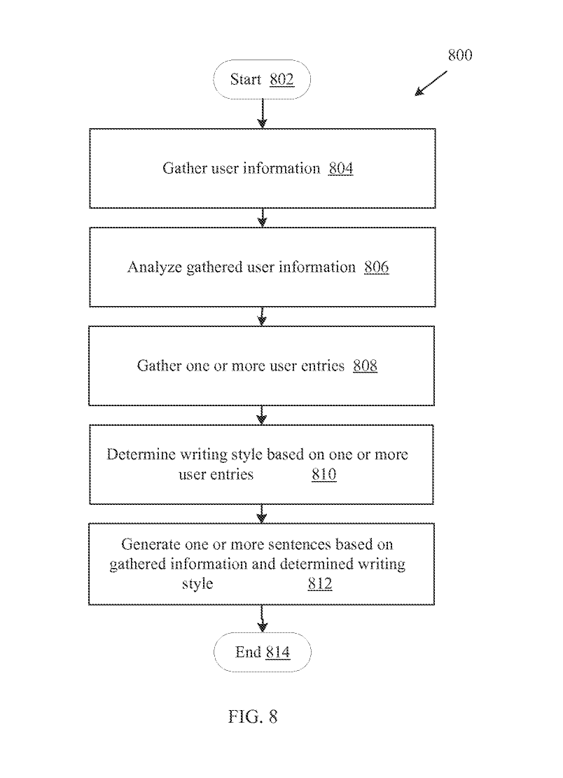

FIG. 8 is a flow chart illustrating another method for generating sentences, in accordance with an embodiment of the disclosure. FIG. 8 is explained in conjunction with elements from FIG. 1. With reference to FIG. 8, exemplary steps may begin at step 802. At step 804, the sentence generating apparatus 106 may gather user information. At step 806, the sentence generating apparatus 106 may analyze the gathered user information. At step 808, the sentence generating apparatus 106 may gather one or more user input entries. At step 810, the sentence generating apparatus 106 may determine a writing style based on one or more user input entries. At step 812, the sentence generating apparatus 106 may generate one or more sentences based on gathered information and determined writing style. Control then passes to end step 814.

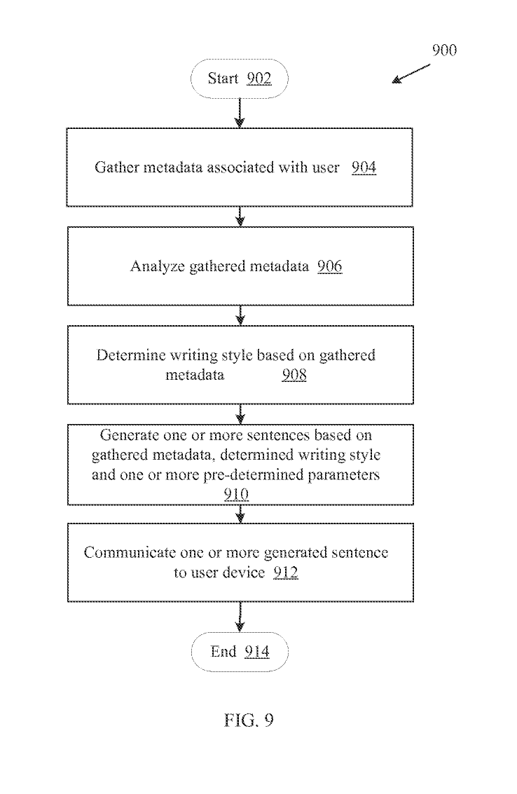

FIG. 9 is a flow chart illustrating another method for generating sentences, in accordance with an embodiment of the disclosure. FIG. 9 is explained in conjunction with elements from FIG. 1. With reference to FIG. 9, exemplary steps may begin at step 902. At step 904, the sentence generating apparatus 106 may gather metadata associated with user. At step 906, the sentence generating apparatus 106 may analyze the gathered metadata. At step 908, the sentence generating apparatus 106 may determine the writing style based on the gathered metadata. At step 910, the sentence generating apparatus 106 may generate one or more sentences based on the gathered metadata, the determined writing style and one or more pre-determined parameters. At step 912, the sentence generating apparatus 106 may communicate one or more generated sentences to the user device. Control then passes to end step 914.

In accordance with an embodiment of the disclosure, an apparatus and method for auto-generation of journal entries may comprise one or more processors and/or circuits. Exemplary aspects of the disclosure may comprise the one or more processors and/or circuits in a user device (such as user device 104a). The one or more processors and/or circuits may be operable to receive information associated with a user from one or more sources (such as weather information 410, location data 412, pictures taken and friends tagged 414, and/or information from social network 416). The one or more processors and/or circuits may be operable to analyze the received information to determine journal information that may be included in the journal entry. The one or more processors and/or circuits may be operable to determine a writing style of the user based on one or more writing samples associated with the user. The one or more processors and/or circuits may be operable to generate one or more sentences for the journal entry, based on the determined journal information, the determined writing style of the user, and one or more pre-determined parameters associated with the user.

The one or more processors and/or circuits may be operable to generate one or more sentences for the journal entry based on a weight assigned to each of the one or more pre-determined parameters associated with the user. The one or more pre-determined parameters may comprise one or more of an age of the user, a gender of the user, an educational background of the user and/or the like. The received information may be one or more of a location, an activity of the user, weather at the location, previous journal entries of the user and/or a personal profile of the user. The one or more sources may comprise one or both of World Wide Web and/or one or more sensors associated to user devices 104 in the proximity of the user.

In accordance with another embodiment of the disclosure, a method and apparatus for auto-generation of journal may comprise one or more processors and/or circuits. Exemplary aspects of the disclosure may comprise the one or more processors and/or circuits in a computing device (such as server 102 and user device 104a). The one or more processors and/or circuits may be operable to aggregate metadata associated with a user from one or more sources (such as weather information 410, location data 412, pictures taken and friends tagged 414, and/or information from social network 416). The one or more processors and/or circuits may be operable to determine a writing style which corresponds to the user based on analyzing the aggregated metadata. The one or more processors and/or circuits may be operable to generate one or more sentences for the journal entry based on the determined writing style, the aggregated metadata, and one or more pre-determined parameters associated with the user. The one or more processors and/or circuits may be operable to communicate the generated one or more sentences to an electronic device.

The one or more sources may comprise one or both of World Wide Web and/or one or more sensors. The one or more pre-determined parameters comprise one or more of an age of the user, a gender of the user, an educational background of the user and/or the like.

Other embodiments of the disclosure may provide a non-transitory computer readable medium and/or storage medium, and/or a non-transitory machine readable medium and/or storage medium. Having applicable mediums stored thereon, a machine code and/or a computer program having at least one code section for generating a journal entry executable by a machine and/or a computer for generating a journal entry, may thereby cause the machine and/or computer to perform the steps comprising receiving information associated with a user from one or more sources, analyzing the received information to determine journal information to be included in the journal entry, determining a writing style of the user based on the received information, generating one or more sentences for the journal entry based on the determined journal information, the determined writing style of the user, and one or more pre-determined parameters associated with the user.

Other embodiments of the disclosure may provide a non-transitory computer readable medium and/or storage medium, and/or a non-transitory machine readable medium and/or storage medium. Having applicable mediums stored thereon, a machine code and/or a computer program having at least one code section executable by a machine and/or a computer for generating one or more sentences, may thereby cause the machine and/or computer to perform the steps comprising aggregating metadata associated with a user from one or more sources, determining a writing style associated with the user based on a user input, generating one or more sentences based on the aggregated metadata, the selected writing style, and one or more pre-determined parameters associated with the user.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when being loaded and executed, may control the computer system such that it carries out the methods described herein. The present disclosure may be realized in hardware that comprises a portion of an integrated circuit that also performs other functions.

The present disclosure may also be embedded in a computer program product, which comprises all the features enabling the implementation of the methods described herein, and which when loaded in a computer system is able to carry out these methods. Computer program, in the present context, means any expression, in any language, code or notation, of a set of instructions intended to cause a system having an information processing capability to perform a particular function either directly, or after either or both of the following: a) conversion to another language, code or notation; b) reproduction in a different material form.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

What is claimed is:

1. A method for generating a journal entry, said method comprising:
in an electronic device:
receiving information associated with a user from one or more sources;
analyzing said received information to determine journal information to be included in said journal entry;
determining a writing style of said user based on said received information; and
generating one or more sentences for said journal entry based on said determined journal information, said determined writing style of said user, and one or more pre-determined parameters associated with said user.

2. The method of claim 1, comprising generating said one or more sentences for said journal entry based on a weight assigned to each of said one or more pre-determined parameters associated with said user.

3. The method of claim 1, wherein said received information is one or more of: a location, an activity of said user, weather at said location, previous journal entries of said user and/or a personal profile of said user.

4. The method of claim 1, wherein said one or more sources are pre-defined by said user.

5. The method of claim 1, wherein said one or more sources comprises one or both of: World Wide Web and/or one or more sensors.

6. The method of claim 1, wherein said one or more pre-determined parameters comprises one or more of: an age of said user, a gender of said user and/or an educational background of said user.

7. An apparatus for generating a journal entry, said apparatus comprising:
one or more processors and/or circuits being operable to:
receive information associated with a user from one or more sources;
analyze said received information to determine journal information to be included in said journal entry; and
determine a writing style of said user based on one or more writing samples associated with said user; and
generate one or more sentences for said journal entry based on said determined journal information, said determined writing style of said user, and one or more pre-determined parameters associated with said user.

8. The apparatus of claim 7, wherein said one or more processors and/or circuits are operable to generate said one or more sentences for said journal entry based on a weight assigned to each of said one or more pre-determined parameters associated with said user.

9. The apparatus of claim 7, wherein said one or more pre-determined parameters comprises one or more of: an age of said user, a gender of said user and/or an educational background of said user.

10. The apparatus of claim 7, wherein said received information is one or more of: a location, an activity of said user, weather at said location, previous journal entries of said user and/or a personal profile of said user.

11. The apparatus of claim 7, wherein said one or more sources comprises one or both of: World Wide Web and/or one or more sensors.

12. A method for generating one or more sentences, said method comprising:
in an electronic device:
aggregating metadata associated with a user from one or more sources;
determining a writing style associated with said user based on a user input; and
generating said one or more sentences based on said aggregated metadata, said determined writing style, and one or more pre-determined parameters associated with said user.

13. The method of claim 12, wherein said user input comprises one or more of: a particular writing style, an e-mail written by said user, a text message written by said user, and/or a journal entry written by said user.

14. The method of claim 12, comprising generating one or more subsequent sentences that are linked to said generated said one or more sentences based on said aggregated metadata, said determined writing style, and said one or more pre-determined parameters associated with said user.

15. The method of claim 12, wherein said one or more sources comprises one or more of: World Wide Web and/or one or more sensors.

16. The method of claim 15, wherein said one or more sensors comprises an ambient light level sensor, a rain sensor and/or a proximity sensor.

17. The method of claim 12, wherein said one or more pre-determined parameters comprises one or more of: an age of said user, a gender of said user and/or an educational background of said user.

18. The method of claim 12, comprising generating said one or more sentences based on a weight assigned to each of said one or more pre-determined parameters.

19. An apparatus for generating a journal entry, said apparatus comprising:
one or more processors and/or circuits in a computing device being operable to:
aggregate metadata associated with a user from one or more sources;
determine a writing style corresponding to said user based on analyzing said aggregated metadata;
generate one or more sentences for said journal entry based on said determined writing style, said aggregated metadata, and one or more pre-determined parameters associated with said user; and
communicate said generated one or more sentences to an electronic device.

20. The apparatus of claim 19, wherein said one or more sources comprises one or both of: World Wide Web and/or one or more sensors.

21. The apparatus of claim 19, wherein said one or more pre-determined parameters comprises one or more of: an age of said user, a gender of said user and/or an educational background of said user.
